(19) United States
(12) Patent Application Publication
(10) Pub. No.: US 2018/0124493 A1
(43) Pub. Date: May 3, 2018

(54) Galvanic linkage for smart sock or other wearable devices

(71) Applicant: BRAGI GmbH, Munchen (DE)

(72) Inventors: Peter Vincent Boesen, Munchen (DE); Darko Dragicevic, Munchen (DE)

(73) Assignee: BRAGI GmbH, Munchen (DE)

(21) Appl. No.: 15/797,834

(22) Filed: Oct. 30, 2017

Related U.S. Application Data
(60) Provisional application No. 62/416,452, filed on Nov. 2, 2016.

(51) Int. Cl. H04R 1/10; H02J 7/02

(52) U.S. Cl. CPC H04R 1/1025; H04B 13/005; H02J 7/025

(57) ABSTRACT

A system includes an earpiece having an earpiece housing, a processor disposed within the earpiece housing, a microphone operatively connected to the processor, a speaker operatively disposed within the ear piece housing and operatively connected to the processor, a plurality of electrodes positioned on the earpiece housing to come in contact with skin of a user, and a charge storage device disposed within the earpiece housing and operatively connected to the processor and the plurality of electrodes. The earpiece is adapted to receive galvanically communicated signals from a remote body worn device at the plurality of electrodes and apply a charge to the charge storage device. The system may further include a sock including a smart material, a plurality of coils, and a plurality of electrodes operatively connected to the plurality of coils, wherein the sock provides for generating the signals and galvanically communicating the signals to the earpiece.

### PRIORITY STATEMENT

This application claims priority to U.S. Provisional Patent Application 62/416,452, filed on Nov. 2, 2016, and entitled Galvanic linkage for smart sock or other wearable devices, hereby incorporated by reference in its entirety.

### FIELD OF THE INVENTION

The present invention relates to wearable devices. More particularly, but not exclusively, the present invention relates to earpieces and linkages with other wearable devices such as smart socks.

### BACKGROUND

Wearable devices are becoming increasingly popular. One of the problems with wearable devices is constraints placed on the devices in order to power the devices. For example, power requirements may require large batteries which may lead to awkward product design. In addition, where rechargeable batteries are used, the use of wearable devices may be frustrating for users who may have a number of different devices which require charging and may involve different cables, connectors, or batteries.

U.S. Pat. No. 6,754,472 to Williams et al., hereby incorporated by reference in its entirety, discloses a method and apparatus for transmitting power and data using the human body. What is needed are new and improved wearable devices such as smart socks or other wearable devices which may provide power to other devices.

### SUMMARY

Therefore, it is a primary object, feature, or advantage of the present invention to improve over the state of the art.

It is a further object, feature, or advantage of the present invention to allow for external powering of an earpiece.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by an object, feature, or advantage stated herein.

According to one aspect a system includes an earpiece having an earpiece housing, a processor disposed within the earpiece housing, a microphone operatively connected to the processor, a speaker operatively disposed within the ear piece housing and operatively connected to the processor, a plurality of electrodes positioned on the earpiece housing to come in contact with skin of a user, and a charge storage device disposed within the earpiece housing and operatively connected to the processor and the plurality of electrodes. The earpiece is adapted to receive galvanically communicated signals from a remote body worn device at the plurality of electrodes and apply a charge to the charge storage device. The system may further include a sock including a smart material, a plurality of coils, and a plurality of electrodes operatively connected to the plurality of coils, wherein the sock provides for generating the signals and galvanically communicating the signals to the earpiece. The signals received from the remote body worn device may include data and the earpiece may be adapted to process the signal to extract the data. The charge storage device need not be a battery and may include a capacitor such as a super capacitor or an ultra capacitor.

According to another aspect, a method of galvanically powering an earpiece is provided.

The earpiece may include an earpiece housing, a processor disposed within the earpiece housing, a microphone operatively connected to the processor, a speaker disposed within the ear piece housing and operatively connected to the processor, a plurality of electrodes positioned on the earpiece housing to come in contact with skin of a user, and a charge storage device disposed within the earpiece housing and operatively connected to the processor and the plurality of electrodes. The method may include receiving a galvanically communicated signal from a remote body worn device at the plurality of the electrodes positioned on the earpiece housing, charging the charge storage device with charge derived from the galvanically communicated signal, and powering the earpiece with the charge storage device. The method may further include providing a sock comprising a smart material, a plurality of coils, and a plurality of electrodes operatively connected to the plurality of coils, wherein the sock is the remote body worn device. The method may further include sending the galvanically communicated signal from the plurality of electrodes of the sock over the skin to the plurality of the electrodes positioned on the earpiece housing. The method may further include extracting data from the galvanically communicated signal by the earpiece.

### BRIEF DESCRIPTION OF THE DRAWINGS

FIG. 1 includes one embodiment of a block diagram of the system.

FIG. 2 includes a second embodiment of a block diagram of the system.

FIG. 3 illustrates a left earpiece and a right earpiece.

FIG. 4 illustrates a flowchart of a method of galvanically powering an earpiece.

FIG. 5 illustrates one example of a system where wearable devices are in operative communication with each other.

FIG. 6 illustrates a cross-section of a sock configured to generate electrical energy from movement.

### DETAILED DESCRIPTION

A wireless earpiece and related methods and systems provide for receiving power and/or data over a galvanic linkage between the wireless earpiece and one or more remote body worn devices such as socks, articles of clothing, articles of jewelry, watches, or other devices. DC signals such as pulsed DC signals or AC signals may be communicated between remote body worn devices and a wireless earpiece. These signals may be harnessed in order to power the wireless earpiece. In one example, a sock configured to generate such a signal provides for galvanically communicating the signal to the wireless earpiece.

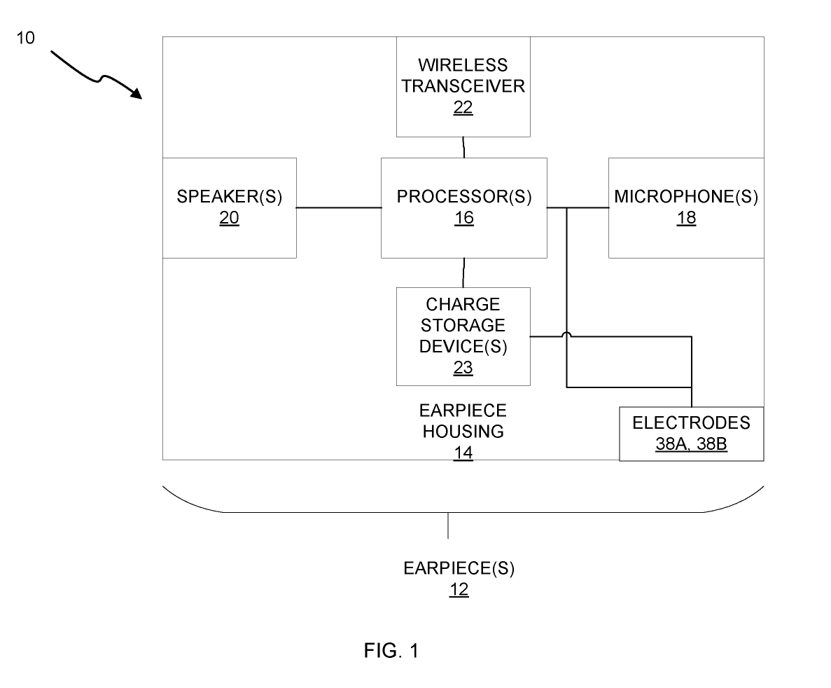

FIG. 1 illustrates one embodiment of a system 10 which includes an earpiece 12 having an earpiece housing 14 and various components disposed within the earpiece housing 14. A processor 16 is disposed within the earpiece housing 14, a microphone 18 is operatively connected to the processor 16, a speaker 20 is operatively connected to the processor 16, a wireless transceiver is 22 operatively connected to the processor 16. The earpiece 10 is configured to receive signals from a remotely located body worn device device, and a charge storage device 23 disposed within the earpiece housing 12 and operatively connected to the processor 16 and the wireless transceiver 22 and configured to store charge derived from the signals received through the electrodes 38A, 38B. Thus, the system is galvanically powered by charge derived from the signals received from the electrodes 38A, 38B. The charge storage device 23 may be a capacitor or super capacitor, ultra capacitor, battery or other type of charge storage device

The processor 16, in addition to being disposed within the earpiece housing 14, may be configured to process the signals received from the wearable devices through the electrodes 38A, 38B, wherein the signals may encode data such as sensor readings, audio, sound, instructions, or information, and execute one or more commands derived from the signals. The processor 16 may also store data from one or more signals within a data storage device or execute one or more programs or algorithms related to the earpiece 12. In addition, the processor 16 may also process inputs received from the microphone 18 or another external electronic device and either store the inputs or communicate them to the user or a third party.

The wireless transceiver 22, in addition to being operatively connected to the processor 16, may receive one or more signals from one or more wearable devices or one or more signals from another electronic device. The signals from each source may be received simultaneously. For example, the wireless transceiver 22 may simultaneously receive one signal from a wearable device related to, for example, the user's heart rate, receive another signal from an external electronic device which may encode information related the current weather, and receive another signal from someone trying to call the user.

The charge storage device 23, in addition to being disposed within the earpiece housing 14 and operatively connected to the processor 16 and the wireless transceiver 22, may be configured to store charge derived from the signals received through the electrodes 36A, 36B. The charge may be used to continuously or intermittently power one or more components of the earpiece 12 or the charge may be stored for future use. The charge storage device 23 may also provide excess power or charge to one or more components if the carrying capacity of the charge storage device is near its limit.

Electrodes 38A, 38B are operatively connected to the charge storage devices 23. Although not shown, filters, converters, or other signal or power conditioning circuitry may be present. The electrodes 38A, 38B are used to contact a skin surface of a user in order to communicate signals across the skin of the user.

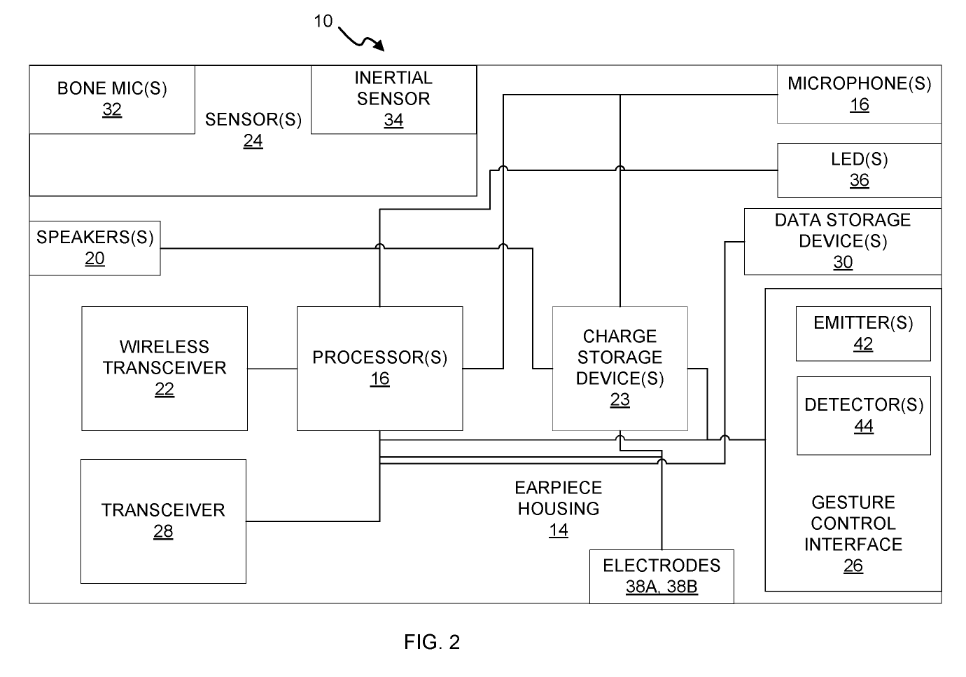

FIG. 2 is a block diagram of the system 10 comprising an earpiece 12 having an earpiece housing 14 and various components disposed within the earpiece housing 14. A processor 16 is disposed within the earpiece housing 14, at least one microphone 18 is operatively connected to the processor 16, a speaker 20 is operatively connected to the processor 16, a wireless transceiver 22 is operatively connected to the processor 16, a charge storage device 23 is also disposed within the earpiece housing 14 and operatively connected to the processor 16 and the wireless transceiver 22. One or more sensors 24 are shown which may include, for example, a bone microphone 32 and/or an inertial sensor 34. A gesture control interface 26 is operatively connected to the processor 16. The gesture control interface may include at least one emitter 42 and at least one detector 44 operatively connected to the processor 16. A transceiver 28 may be disposed within the earpiece housing 14, a data storage device 30 may be operatively connected to the processor 16. At least one LED 36 may be operatively connected to the processor 16. A plurality of electrodes 38A, 38B for contacting the skin of the user may be operatively connected to the charge storage device 32 and the processor 16.

The earpiece housing 14 may be composed of one or more metal or plastic materials that are substantially resistant to straining and shearing stresses and may also have a sheath attached in order to improve comfort, sound transmission, or reduce the likelihood of skin or ear allergies. In addition, the earpiece housing 14 may also substantially encompass an outer opening of the user's ear canal in order to substantially reduce or eliminate external sounds to further improve audio transparency and may be also be configured to substantially fit with the user's ear canal to facilitate audio transmission.

A processor 16 may be disposed within the earpiece housing 14 and operatively connected to all of the components within the earpiece 12 and may be configured to process one or more signals from a wearable device, process voice commands from a user or a third party, process signals from the wireless transceiver 22, process signals from the transceiver 28, process signals originating from the data storage device 30, process signals from the bone conduction microphone 32, or process signals from the inertial sensor 34, wherein the signals may encode for music, newscasts, podcasts, commentary, instructions, information related to sensor readings, or other forms of digital media and/or information. The processor 16 may also, in addition to processing the aforementioned signals, produce the signals from the microphone 18, the wireless transceiver 22, the transceiver 28, the data storage device 30, the bone conduction microphone 32, or the inertial sensor 34 at the speaker 20. The processor 16 may also be reconfigured by the user or a third party through the use of gestures read by a gestural control interface 26, a voice command received by one or more microphones 18, or a signal received by the wireless transceiver 22 or the transceiver 28.

A wireless transceiver 22 may be disposed within the earpiece housing 14 and operatively connected to the processor 16 and may be configured to, in addition to receiving signals from and transmitting signals to at least one wearable device, receive signals from external electronic devices and/or transmit those signals to the processor 16. The external electronic devices the wireless transceiver 22 may be configured to receive signals from include Bluetooth devices, mobile devices, desktops, laptops, tablets, modems, routers, communications towers, cameras, watches, third-party earpieces, earpieces, or other electronic devices capable of transmitting or receiving wireless signals. The signals received from or transmitted to a wearable device may encode for music, sound, instructions, information, or other media or informational matters. The wireless transceiver 22 may also receive or transmit more than one signal simultaneously. For example, the wireless transceiver 22 may simultaneously receive one signal from a wearable device related to, for example, the user's heart rate, receive another signal from an external electronic device which may encode information related the current weather, receive another signal from someone trying to call the user, and transmit a signal to a communications tower providing information on the location of the user. The signals received by the wireless transceiver 22 may also be used to power the earpiece 12.

One or more charge storage devices 23 may be operatively connected to all of the components within the earpiece 12 and may be configured to store charge derived from one or more signals originating from a wearable device, a body sensor, an external electronic device, or a combination of the aforementioned and use the charge to power one or more components of the earpiece 12. The charge may be provided to each earpiece component simultaneously or may be provided on an as-needed basis. The charge may also be delivered to one or more components if the carrying capacity on one or more capacitors is near its operational limits.

One or more sensors 24 may be operatively connected to the processor 16 and may be configured to sense at least one user motion and may also be configured to read sounds or motions that may not be ascertainable by other components of the earpiece 12. For example, a bone conduction microphone 32 may be configured to receive body sounds from the temporal bone of the user's skull and transmit the body sounds to the processor 16, which may then create a noise cancellation sound configured to substantially neutralize each unique body sound the processor 16 receives using destructive interference techniques. An inertial sensor 34 may also be employed to ascertain the movement of the user. For example, the inertial sensor 34 may sense a running speed of the user or an arm speed of a third party which may be communicated to the processor 16, which may be used to produce feedback at the speaker 20 to the user. Each sensor 24 may be positioned at any location in or on the earpiece housing 14 conducive to receiving information and need not necessarily be in direct contact with either the user or the external environment.

A gesture control interface 26 having at least one emitter 42 and a detector 44 may be operatively connected to the earpiece housing 14 and the processor 16 and may be configured to allow the user or a third party to control one or more functions of the earpiece 12. For example, a menu may be prompted through the use of a gesture with the gestural control interface 26, which may allow the user or a third party to listen to a song either stored within the data storage device 30 or received through the wireless transceiver 22, listen to a playlist, newscast, podcast, or a weather report received through the wireless transceiver 22 or stored within the data storage device 30, obtain information on the user's current surroundings, or anything else that may be of interest to the user or a third party, and the aforementioned list is non-exclusive. The selections may be chosen through the use of one or more additional gestures or through the use of one or more voice commands from the user and/or a third party. The types of gestures that may be used with the gesture control interface 26 to control the earpiece 12 include, without limitation, touching, tapping, swiping, use of an instrument, or any combination of the aforementioned gestures. Touching gestures used to control the earpiece 12 may be of any duration and may include the touching of areas that are not part of the gesture control interface 26. Tapping gestures used to control the earpiece 12 may include one or more taps and need not be brief. Swiping gestures used to control the earpiece 12 may include a single swipe, a swipe that changes direction at least once, a swipe with a time delay, a plurality of swipes, or any combination of the aforementioned. An instrument used to control the earpiece 12 may be electronic, biochemical or mechanical, and may interface with the gesture control interface 26 either physically or electromagnetically.

A transceiver 28 may be disposed within the earpiece housing 14 and may be configured to receive signals from and to transmit signals to a second earpiece of the user if the user is using more than one earpiece. The transceiver 28 may receive or transmit more than one signal simultaneously. The transceiver 28 may be of any number of types including a near field magnetic induction (NFMI) transceiver.

One or more data storage devices 30 may be operatively connected to the earpiece housing 14 and the processor 16 and may be configured to store data or information related to one or more signals received from a wearable device, body sensor, external electronic device, or a combination of the aforementioned. One or more data storage devices 30 may also have one or more programs preinstalled which may be (1) used by the processor 16 in processing one or more signals, (2) used by the processor 16 in executing one or more commands to be carried out by one or more components of the earpiece 12, (3) accessible via a gesture or voice command, or (4) transmitted to an external electronic device.

One or more LEDs 36 may be operatively connected to the earpiece housing 14 and the processor 16 and may be configured to emit light in order to convey information to a user concerning the earpiece 12. The LEDs 36 may be located in any area on the earpiece 12 suitable for viewing by the user or a third party and may consist of as few as one diode which may be provided in combination with a light guide. In addition, the LEDs 36 may be discernable by a human eye or an electronic device and need not have a minimum luminescence.

Electrodes 38A, 38B may be operatively connected to the earpiece housing 14 and the charge storage device 23. The electrodes 38A, 38B may be located anywhere on the earpiece housing 14 that may come in contact with a skin of a user.

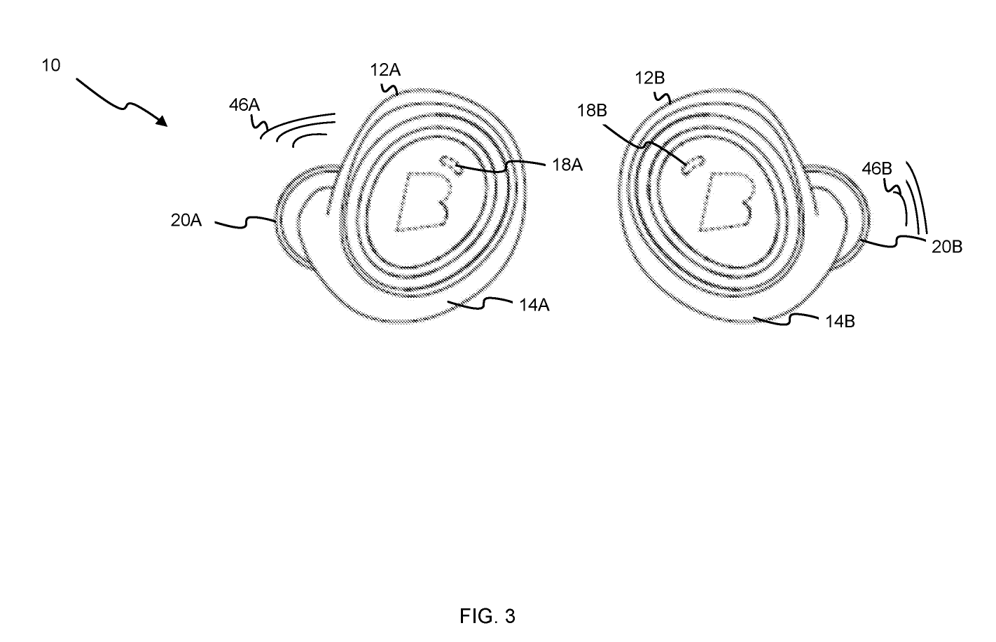

FIG. 3 illustrates a pair of earpieces 12 which includes a left earpiece 12A and a right earpiece 12B. The left earpiece 12A has a left earpiece housing 14A. The right earpiece 12B has a right earpiece housing 14B. The left earpiece 12A and the right earpiece 12B may be configured to substantially encompass an outer opening of a user's ear canal in order to substantially prevent external sounds from reaching the user's ear canal and/or fit within the user's ear canal in order to minimize the distance between the speakers and a user's tympanic membranes. The earpiece housings 14A and 14B may be composed of metallic materials, plastic materials, or any material with substantial shear and strain resistance and may also be configured to be soundproof in order to improve audio transparency. A microphone 18A is shown on the left earpiece 12A and a microphone 18B is shown on the right earpiece 12B. The microphones 18A and 18B may be located anywhere on the left earpiece 12A and the right earpiece 12B respectively and each microphone may be configured to receive one or more voice commands. Speakers 20A and 20B may be configured to communicate sounds 46A and 46B. The sounds 46A and 46B may be communicated to the user, a third party, or another entity capable of receiving the communicated sounds.

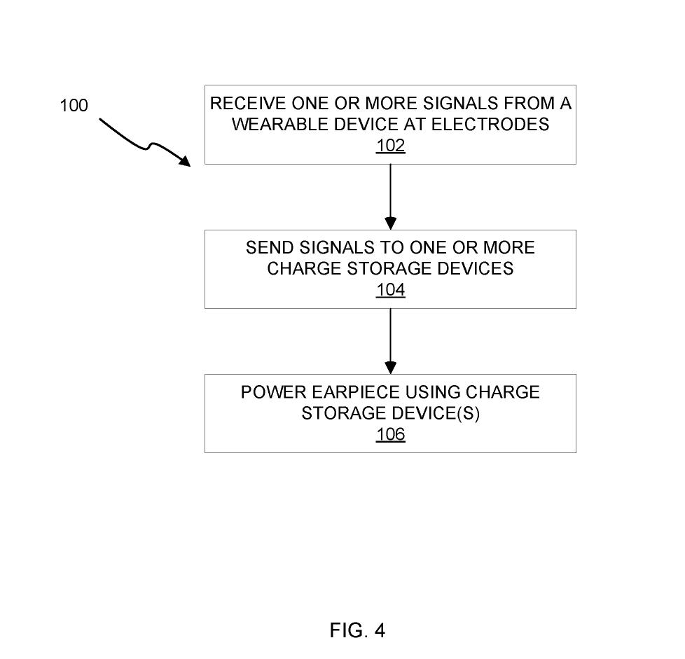

FIG. 4 illustrates a flowchart of a method of galvanically powering an earpiece 100. First, in step 102, electrodes receive at least one signal from a wearable device. The wearable device may transmit one or more signals through the user's skin, and more than one wearable device may be involved. For example, the earpiece may simultaneously receive signals from a smart sock and a smart watch. In addition, in some embodiments the signals received may encode data or information related to the user. In such instances data may be filtered from the signal or a data signal may be rectified or otherwise processed to provide a power signal. In step 104, the signal is received at or more charge storage devices. In step 106, one or more charge storage devices power the earpiece. The charge storage device may power each component within the earpiece simultaneously or may power each component depending on the energy needs of the component.

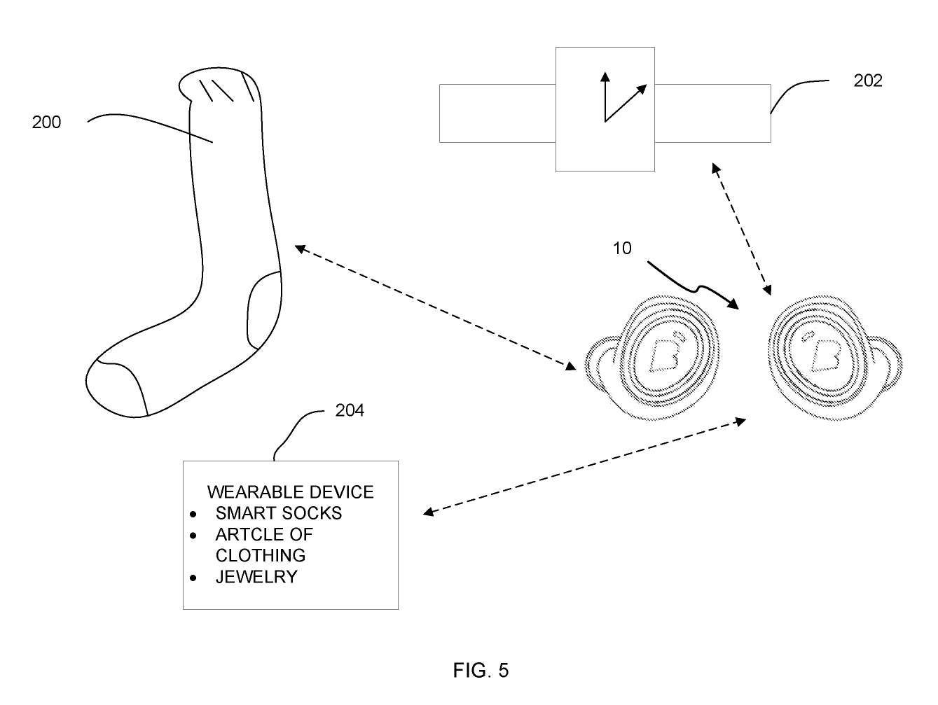

FIG. 5 is a pictorial representation of wearable devices in operative communication with each other. A sock 200 is shown which is in operatively communication with earpieces 10. The sock 200 is in contact with the skin of a user. The earpieces 10 are also in contact with skin of the same user so that signals may be galvanically communicated between the earpieces 10 and the sock 200. One or more other wearable devices may also be in contact with the earpieces 10. This may include smart socks 200, watches 202, other articles of clothing, jewelry items, or other wearable devices. It is contemplated that the sock 200 may be used to generate electrical energy such as by including one or more layers of magneto-resistive material or other smart material within the sock so that as a person walks or runs, electrical energy is generated. Thus, movement of the user may be converted into electrical energy. The sock 200 may include a smart material which produces electrical energy in response to a force being applied. In one embodiment a plurality of coils may be used to harvest the electrical energy. The electrical energy from the sock may then be galvanically communicated through the skin to other wearable devices such as the earpieces 10 and then stored in a charge storage device such as a capacitor, super capacitor, ultra capacitor, battery, or other type of charge storage device. The galvanically communicated signal may be filtered or otherwise conditioned into a form which may be stored.

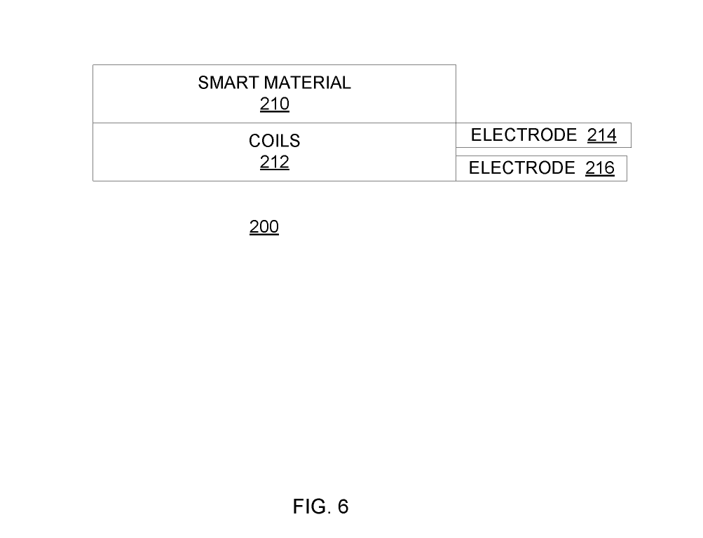

FIG. 6 illustrates one example of a sock 200 which is formed from a plurality of layers which may include a smart material 210 and coils 212 which may be used to harvest electrical energy from the smart material 210. Electrodes 214, 216 may then be placed in contact with the skin of the user to electrically convey the harvested signal to other electrodes within the body. It is contemplated that in some embodiments, additional signal filtering and conditioning may be performed in order to increase efficiency of the signal being communicated to one or more other wearable devices on the body. It is also to be understood that the structure shown in FIG. 6 may also be applied to other type of wearable devices including clothing or other wearable items.

Therefore, various apparatus, methods, and systems have been shown and described throughout. Although various specific embodiments are shown, it is to be understood that other options, variations, and alternatives are contemplated as may be appropriate for particular applications or environments.

What is claimed is:

1. A system comprising:
an earpiece having an earpiece housing;
a processor disposed within the earpiece housing;
a microphone operatively connected to the processor;
a speaker operatively disposed within the ear piece housing and operatively connected to the processor;
a plurality of electrodes positioned on the earpiece housing to come in contact with skin of a user;
a charge storage device disposed within the earpiece housing and operatively connected to the processor and the plurality of electrodes;
wherein the earpiece is adapted to receive galvanically communicated signals from a remote body worn device at the plurality of electrodes and apply a charge to the charge storage device.

2. The system of claim 1 further comprising a sock comprising a smart material, a plurality of coils, and a plurality of electrodes operatively connected to the plurality of coils, wherein the sock provides for generating the signals and galvanically communicating the signals to the earpiece.

3. The system of claim 1 wherein the signals received from the remote body worn device comprises data and wherein the earpiece is adapted to process the signal to extract the data.

4. The system of claim 1 wherein the charge storage device is not a battery.

5. The system of claim 1 wherein the charge storage device comprises a capacitor.

6. The system of claim 5 wherein the charge storage device comprises at least one of a super capacitor and an ultra capacitor.

7. A method of galvanically powering an earpiece, the earpiece comprising an earpiece housing, a processor disposed within the earpiece housing, a microphone operatively connected to the processor, a speaker disposed within the ear piece housing and operatively connected to the processor, a plurality of electrodes positioned on the earpiece housing to come in contact with skin of a user, and a charge storage device disposed within the earpiece housing and operatively connected to the processor and the plurality of electrodes, the method comprising:
receiving a galvanically communicated signal from a remote body worn device at the plurality of the electrodes positioned on the earpiece housing;
charging the charge storage device with charge derived from the galvanically communicated signal; and
powering the earpiece with the charge storage device.

8. The method of claim 7 further comprising:
providing a sock comprising a smart material, a plurality of coils, and a plurality of electrodes operatively connected to the plurality of coils, wherein the sock is the remote body worn device;
sending the galvanically communicated signal from the plurality of electrodes of the sock over the skin to the plurality of the electrodes positioned on the earpiece housing.

9. The method of claim 8 further comprising: extracting data from the galvanically communicated signal by the earpiece.

10. The method of claim 9 further comprising encoding data within the galvanically communicated signal by the wireless earpiece.

11. The method of claim 7 further comprising encoding, by the remote body worn device, data into the galvanically communicated signal.

12. The method of claim 11 further comprising extracting the data from the galvanically communicated signal by the wireless earpiece.

13. The method of claim 7 wherein the charge storage device is not a battery.

14. The method of claim 7 wherein the charge storage device comprises a capacitor.

15. The method of claim 14 wherein the charge storage device comprises a super capacitor.

16. The method of claim 13 wherein the remote body worn device is a sock.
